(19) United States
(12) Patent Application Publication
(10) Pub. No.: US 2021/0232861 A1
(43) Pub. Date: Jul. 29, 2021

(54) CREATION DEVICE, CREATION METHOD, AND PROGRAM

(71) Applicant: NIPPON TELEGRAPH AND TELEPHONE CORPORATION, Tokyo (JP)

(72) Inventors: Atsutoshi KUMAGAI, Musashino-shi, Tokyo (JP); Tomoharu IWATA, Musashino-shi, Tokyo (JP)

(73) Assignee: NIPPON TELEGRAPH AND TELEPHONE CORPORATION, Tokyo (JP)

(21) Appl. No.: 17/051,458

(22) PCT Filed: May 15, 2019
(86) PCT No.: PCT/JP2019/019399

§ 371 Date: Oct. 29, 2020

(30) Foreign Application Priority Data
May 16, 2018 (JP) 2018-094927

(51) Int. Cl. G06K 9/62; G06N 20/00

(52) U.S. Cl. CPC G06K 9/6256; G06N 20/00; G06K 9/6269; G06K 9/626

(57) ABSTRACT

A learning section (13) learns a classification criterion of a classifier at each time point using labeled learning data collected until a past prescribed time point and unlabeled learning data collected on and after the prescribed time point and learns a time-series change of the classification criterion. A classifier creation section (14) predicts a classification criterion of the classifier at an arbitrary time point including a future time point and certainty expressing the reliability of the classification criterion using the learned classification criterion and the time-series change. Thus, the classifier that outputs a label expressing an attribute of input data is created.

### TECHNICAL FIELD

The present invention relates to a creation device, a creation method, and a creation program.

### BACKGROUND ART

In machine learning, a known classifier outputs a label expressing the attribute of data when receiving the data. For example, when receiving a newspaper article as data, a classifier outputs a label such as politics, economy, and sports. The classifier performs the classification of data on the basis of the feature of the data of each label. The learning or creation of a classifier is performed by learning the feature of data using labeled data (hereinafter also referred to as labeled learning data) in which data for learning (hereinafter also referred to as learning data) and the label of the learning data are combined together.

A classification criterion that is a reference value for classification in a classifier possibly changes with time. For example, a spam mail creator creates spam mail having a new feature at all times in order to slip through a classifier. Therefore, a classification criterion for spam mail changes with time, and the classification accuracy of the classifier greatly decreases.

For example, a classifier that solves a binary problem in which mail is classified into spam mail or another type of mail analyzes a word of mail and determines the mail as spam mail if the mail contains a corresponding word. A word corresponding to spam mail changes with time, and therefore mail is possibly falsely classified without any appropriate response.

In order to prevent such a decrease in the classification accuracy of a classifier, it is necessary to perform the creation of the classifier (hereinafter also referred to as the update of the classifier) of which the classification criterion is updated. In view of this, there has been known a technology in which labeled learning data is continuously collected and a classifier is updated using the collected latest labeled learning data. However, labeled learning data is obtained by manually assigning a label to each learning data. Therefore, the labeled learning data is high in collection cost and difficult to be continuously collected.

In view of this, there has been disclosed a technology in which the time development of a classification criterion is learned from previously-provided past labeled learning data without the addition of labeled learning data and a classification criterion for the future is predicted to prevent the temporal degradation of a classifier (see NPL 1 and NPL 2). Further, there has been disclosed a technology in which data that is low in collection cost due to the absence of a label (hereinafter also referred to as unlabeled data or unlabeled learning data) is added as learning data to perform the update of a classifier (see NPL 3 and NPL 4).

### CITATION LIST

### Non Patent Literature

[NPL 1] Atsutoshi Kumagai, Tomoharu Iwata, “Learning Future Classifiers without Additional Data,” AAAI, 2016
[NPL 2] Atsutoshi Kumagai, Tomoharu Iwata, “Learning Non-Linear Dynamics of Decision Boundaries for Maintaining Classification Performance,” AAAI, 2017
[NPL 3] Atsutoshi Kumagai, Tomoharu Iwata, “Learning Latest Classifiers without Additional Labeled Data”, IJCAI, 2017
[NPL 4] Karl B Dyer, Robert Capo, Robi Polikar, “Compose: A Semisupervised Learning Framework for Initially Labeled Nonstationary Streaming Data,” IEEE Transactions on Neural Networks and Learning Systems, vol. 25, NO. 1, 2014, pp. 12-26

### SUMMARY OF THE INVENTION

### Technical Problem

However, the prediction of the classification criterion of a classifier is generally difficult, and the classification accuracy of the classifier does not necessarily increase. Further, classification accuracy possibly decreases when a classifier is updated using unlabeled learning data.

The present invention has been made in view of the above circumstances and has an object of creating a classifier maintaining its classification accuracy using unlabeled learning data with consideration given to the time development of a classification criterion.

### Means for Solving the Problem

In order to solve the above problems and achieve the object, a creation device according to the present invention is a creation device for creating a classifier that outputs a label expressing an attribute of input data, the creating device including: a classifier learning section that learns a classification criterion of the classifier at each time point using labeled data collected until a past prescribed time point and unlabeled data collected on and after the prescribed time point as learning data; a time-series change learning section that learns a time-series change of the classification criterion; and a prediction section that predicts a classification criterion of the classifier at an arbitrary time point including a future time point and reliability of the classification criterion using the learned classification criterion and the time-series change.

### Effects of the Invention

According to the present invention, a classifier maintaining its classification accuracy can be created using unlabeled learning data with consideration given to the time development of a classification criterion.

### BRIEF DESCRIPTION OF DRAWINGS

FIG. 1 is a schematic diagram showing the schematic configuration of a creation device according to a first embodiment of the present invention.

FIG. 2 is a flowchart showing the creation processing procedure of the first embodiment.

FIG. 3 is a flowchart showing the classification processing procedure of the first embodiment.

FIG. 4 is an explanatory diagram for explaining the effect of creation processing by the creation device of the first embodiment.

FIG. 5 is a schematic diagram showing the schematic configuration of the creation device of a second embodiment.

FIG. 6 is a flowchart showing the creation processing procedure of the second embodiment.

FIG. 7 is a diagram illustrating by example a computer that performs a creation program.

### DESCRIPTION OF EMBODIMENTS

### First Embodiment

Hereinafter, an embodiment of the present invention will be illustrated in detail with reference to the drawings. Note that the present invention is not limited to the embodiment. Further, the same portions will be denoted by the same reference signs in the description of the drawings.

[Configuration of Creation Device]

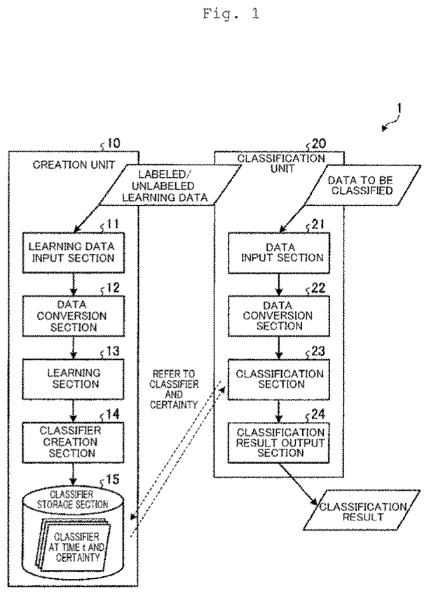

First, the schematic configuration of a creation device according to the present embodiment will be described with reference to FIG. 1. A creation device 1 according to the present embodiment is realized by a general-purpose computer such as a workstation and a personal computer and performs creation processing that will be described later to create a classifier that outputs a label expressing the attribute of input data.

Note that as shown in FIG. 1, the creation device 1 of the present embodiment has, besides a creation unit 10 that performs creation processing, a classification unit 20 that performs classification processing. The classification unit 20 performs classification processing in which data is classified using a classifier that has been created by the creation unit 10 and a label is output. The classification unit 20 may be mounted in hardware same as or different from that of the creation unit 10.

[Creation Unit]

The creation unit 10 has a learning data input section 11, a data conversion section 12, a learning section 13, a classifier creation section 14, and a classifier storage section 15.

The learning data input section 11 is realized by an input device such as a keyboard and a mouse and inputs various instruction information to a control unit in response to an input operation by an operator. In the present embodiment, the learning data input section 11 receives labeled learning data and unlabeled learning data that are to be used in creation processing.

Here, the labeled learning data represents learning data that is assigned a label expressing the attribute of the data. For example, when learning data is text, a label such as politics, economy, and sports expressing the content of the text is assigned. Further, the unlabeled learning data represents learning data that is not assigned a label.

Further, the labeled learning data and the unlabeled learning data are assigned time information. For example, when learning data is text, the time information represents a date and time or the like at which the text was published. In the present embodiment, a plurality of labeled learning data and a plurality of unlabeled learning data that are assigned past different time information up to the present are received.

Note that the labeled learning data may be input from an external server device or the like to the creation unit 10 via a communication control unit (not shown) realized by a NIC (Network Interface Card) or the like.

The control unit is realized by a CPU (Central Processing Unit) or the like that performs a processing program and functions as the data conversion section 12, the learning section 13, and the classifier creation section 14.

The data conversion section 12 converts received labeled learning data into the data of a combination of a collection time, a feature vector, and a numeric value label as preparation for processing by the learning section 13 that will be described later. Further, the data conversion section 12 converts unlabeled learning data into the data of a combination of a collection time and a feature vector. The labeled learning data and the unlabeled learning data in the following processing by the creation unit 10 represent data after being converted by the data conversion section 12.

Here, the numeric value label is one obtained by converting a label assigned to labeled learning data into a numeric value. Further, the collection time is time information that shows time at which learning data was collected. Further, the feature vector is one obtained by writing received labeled learning data as a specific n-dimensional number vector. Learning data is converted by a general-purpose method in machine learning. For example, when learning data is text, the learning data is converted by a morphological analysis, n-gram, or delimiter.

The learning section 13 functions as a classifier learning section and learns the classification criterion of a classifier at each time point using labeled data that was collected until a past prescribed time point and unlabeled data that was collected on an after the prescribed time point as learning data. Further, the learning section 13 functions as a time-series change learning section and learns the time-series change of the classification criterion. In the present embodiment, the learning section 13 performs the learning of a classification criterion as the classifier learning section and the learning of a time-series change as the time-series change learning section in parallel.

Specifically, the learning section 13 simultaneously performs the learning of a classification criterion and the learning of the time-series change of the classification criterion of a classifier using labeled learning data that is assigned collection time of t₁ to t_{L} and unlabeled learning data that is collection time of t_{L+1} to t_{L+U}. In the present embodiment, logistic regression is applied as the model of a classifier with the assumption that an event in which a certain label is assigned by the classifier occurs at a prescribed probability distribution. Note that the model of the classifier is not limited to the logistic regression but may include support vector machine, boosting, or the like.

Further, in the present embodiment, a Gaussian process is applied as a time-series model expressing the time-series change of the classification criterion of a classifier. Note that the time-series model is not limited to the Gaussian process but may include a model such as a VAR model.

First, labeled learning data at time t is expressed by the following expression (1). Note that a label is composed of two discrete values of 0 and 1 in the present embodiment. However, the present embodiment is also applicable to a case in which there are three or more labels or a case in which a label is composed of continuous values.

[Formula 1]

[symbol]

ₜ^{L}:={xₙ^{t},yₙ^{t}}ₙ₌₁^{N}^{ₜ} (1)

where

xₙ^{t} represents the D-dimensional feature vector of the n-th data,

yₙ^{t}∈{0,1} represents the label of the n-th data, and

t^{L}:=(t₁, . . . , t_{L}) represents time at which labeled learning data was collected.

Further, the whole labeled learning data is expressed by the following expression (2).

[Formula 2]

[symbol]

^{L}={ [symbol] ₜ^{L}}ₜ₌ₜ^{t}^{_{L}}, (2)

Further, unlabeled learning data at the time t is expressed by the following expression (3).

[Formula 3]

[symbol]

ₜ^{U}:={xₘ^{t}}ₘ₌₁^{M}^{ₜ} (3)

where

t^{U}:=(t_{L+1}, . . . , t_{L+U}) represents time at which the unlabeled learning data was collected.

Further, the whole unlabeled learning data is expressed by the following expression (4)

[Formula 4]

[symbol]

^{U}={ [symbol] ₜ^{U}}ₜ₌ₜ_{_{L+1}}^{t}^{_{L+U}} (4)

In this case, the probability that the label yₙ^{t} of the feature vector xₙ^{t} is 1 in a classifier to which logistic regression is applied is expressed by the following expression (5).

[Formula 5]

p(yₙ^{t}=1|xₙ^{t},wₜ)=σ(wₜ^{T}xₙ^{t})=(1+c^{-w}^{ₜ}^{^{T}}^{x}^{ₙ}^{^{t}})⁻¹ (5)

where

wₜ∈ [symbol] ^{D} represents the parameter of the classifier (D-dimensional vector),

σ represents a sigmoid function, and

T represents transposition.

It is assumed that a d-component w_{td} of the parameter of the classifier at the time t is described by the following expression (6) using a nonlinear function f_{d}. Here, d is 1 to D.

[Formula 6]

w_{td}=f_{d}(t)+ϵ_{d} (6)

where

f_{d} represents a nonlinear function using the time t as input, and

ε_{d} represents Gaussian noise.

Further, the prior distribution of the nonlinear function f_{d} is based on a Gaussian process. That is, it is assumed that the value of the nonlinear function f_{d} at each time point of the time t of t₁ to t_{L+U} shown in the following expression (7) is generated by a Gaussian distribution shown in the following expression (8).

[Formula 7]

f_{d}=(f_{d}(t₁), . . . ,f_{d}(t_{T})) (7)

[Formula 8]

p(f_{d})= [symbol] (f_{d}|0,K_{d}) (8)

where

N(μ,Σ) represents the Gaussian distribution of an average μ and a covariance matrix Σ, and

K_{d} represents a covariance matrix using a kernel function k_{d} as a component.

Here, each component of the covariance matrix is expressed by the following expression (9).

[Formula 9]

[K_{d}]_{tt′}:=k_{d}(t,t′) (9)

The above k_{d} can be defined by an arbitrary kernel function but is defined by a kernel function shown in the following expression (10) in the present embodiment.

$$\begin{matrix}[ Formula 10 ] & \\ {k}_{d} ( t , {t}^{′} ) = {β}_{d}^{2} exp ( - \frac{1}{2} {α}_{d}^{2} {\vert t - {t}^{′} \vert}^{2} ) + {γ}_{d}^{2} + {ζ}_{d}^{2} {tt}^{′} & ( 10 )\end{matrix}$$

where

α_{d}, β_{d}, γ_{d}, and ζ_{d} represent parameters (actual numbers) featuring dynamics.

In this case, the probability distribution of the parameter (d-component) of the classifier at the time t of t₁ to t_{L+U} shown in the following expression (11) is expressed by the following expression (12).

$$\begin{matrix}[ Formula 11 ] & \\ w {.}_{d} \text{:} = ( {w}_{{t}_{1} d} … , {w}_{{t}_{L + {U}^{d}}} ) ∈ {ℝ}^{L + U} & ( 11 )\end{matrix}$$

[Formula 12]

p(w_{·d})=∫p(w_{·d}|f_{d})p(f_{d})df_{d}= [symbol] (w_{·d}|0,C_{d}) (12)

where

C_{d} represents a covariance matrix in which each component is defined by a kernel function c_{d}.

The component of the covariance matrix is defined by a kernel function c_{d} shown in the following expression (13)

[Formula 13]

c_{d}(t,t′):=k_{d}(t,t′)+δ_{tt′}η_{d}² (13)

where

η_{d} represents a parameter (actual number), and

δₜₜ, represents a function that returns 1 when t is equal to t′ and returns 0 in other cases.

In this case, a simultaneous distribution probability model for learning a classification criterion W of the classifier shown in the following expression (14) and a parameter θ shown in the following expression (15) expressing the time series change (dynamics) of the classification criterion is defined by the following expression (16).

[Formula 14]

W:=(wₜ_{₁}, . . . ,wₜ_{_{L+U}}) (14)

[Formula 15]

θ:=(α₁, . . . ,α_{D},β₁, . . . ,β_{D},γ₁, . . . ,γ_{D},ζ₁, . . . ,ζ_{D},η₁, . . . ,η_{D}) (15)

$$\begin{matrix}[ Formula 16 ] & \\ \begin{matrix}p ( {𝒟}^{L} , W ; θ ) = p ( {𝒟}^{L} \vert W ) p ( W ; θ ) \\ = {\prod }_{t = {t}_{1}}^{{t}_{L}} {\prod }_{n = 1}^{{N}_{t}} p ( {y}_{n}^{t} \vert {x}_{n}^{t} , {w}_{t} ) \cdot {\prod }_{d = 1}^{D} N ( w {.}_{d} \vert 0 , {C}_{d} )\end{matrix} & ( 16 )\end{matrix}$$

Next, on the basis of the probability model defined by the above expression (16), the probability that the classifier of a classification criterion W (hereinafter also referred to as the classifier W) is obtained when the labeled learning data is provided and the dynamics parameter θ are estimated using a so-called variational Bayesian method in which a posterior distribution is approximated from data to be provided. In the variational Bayesian method, a function shown in the following expression (17) is maximized to obtain the distribution of desired W, that is, q(W) and the dynamics parameter θ.

$$\begin{matrix}[ Formula 17 ] & \\ {ℒ}^{L} ( q ; θ ) \text{:} = \int q ( W ) log \frac{p ( {𝒟}^{L} , W ; θ )}{q ( W )} dW & ( 17 )\end{matrix}$$

where

q(W) represents the approximated distribution of the probability p(W|D^{L}) that the classifier W is obtained under the provision of labeled learning data D^{L}.

However, the function shown in the above expression (17) does not depend on the unlabeled learning data. Therefore, in order to practically use the unlabeled learning data, an entropy minimization principle shown in the following expression (18) is applied in the present embodiment so that the decision boundary of the classifier is recommended to pass through a region having low data density.

$$\begin{matrix}[ Formula 18 ] & \\ {R}_{t} ( q ) \text{:} = \int {\sum }_{m = 1}^{{M}_{t}} H ( p ( y \vert {x}_{m}^{t} , wt ) ) q ( W ) dW & ( 18 )\end{matrix}$$

where

time t∈t^{U}

$$H ( p ( y \vert {x}_{m}^{t} , {w}_{t} ) ) \text{:} = - {\sum }_{y ∈ \{ 0 , 1 \}} p ( y \vert {x}_{m}^{t} , {w}_{t} ) log p ( y \vert {x}_{m}^{t} , {w}_{t} )$$

By the minimization of Rₜ in the above expression (18) with respect to wₜ, wₜ is learned to pass through a region having low data density in the unlabeled learning data at the time t. That is, the optimization problem of the present embodiment is to solve an optimization problem shown in the following expression (19).

$$\begin{matrix}[ Formula 19 ] & \\ \begin{matrix}{max}_{q ( W ) , θ} ℒ ( q ; θ ) \text{:} = {ℒ}^{L} ( q ; θ ) - \frac{ρ}{M} R ( q ) \\ = {max}_{q ( W ) , θ} \int q ( W ) log \frac{p ( {𝒟}^{L} , W ; θ )}{q ( W )} dW - \\ \frac{ρ}{M} \int {\sum }_{t = {t}_{L + 1}}^{{t}_{L + U}} {\sum }_{m = 1}^{M t} H ( p ( y \vert {x}_{m}^{t} , {w}_{t} ) ) q ( W ) dW\end{matrix} & ( 19 )\end{matrix}$$

where

R=ΣₜRₜ

ρ represents a positive constant, and

M=ΣₜMₜ.

In order to find the solution of the optimization problem, it is assumed that q(W) can be factorized as shown in the following expression (20).

$$\begin{matrix}[ Formula 20 ] & \\ q ( W ) = {\prod }_{t = {t}_{1}}^{{t}_{L + U}} {\prod }_{d = 1}^{D} q ( {w}_{t d} ) & ( 20 )\end{matrix}$$

Further, it is assumed that q(wₜ) is expressed by the function form of a Gaussian distribution as shown in the following expression (21).

[Formula 21]

q(w_{td})= [symbol] (w_{td}|μ_{td},σ_{td}²) (21)

where

time t∈t^{U}.

In this case, it is found that q(W) is expressed by the function form of a Gaussian distribution shown in the following expression (22).

[Formula 22]

q(w_{td})= [symbol] (w_{td}|μ_{td},λ_{td}⁻¹) (22)

where

q(wₜ) for t∈t^{L}

Here, u_{td} and λ_{td} are estimated using an update expression shown in the following expression (23).

$$[ Formula 23 ] \\ ( 23 ) \\ \begin{matrix}{μ}_{td} ← {λ}_{t d}^{- 1} ( {\sum }_{n = 1}^{{N}_{t}} \{ ( {y}_{n}^{t} - \frac{1}{2} \} {x}_{n d}^{t} - 2 h ( {ζ}_{n}^{t} ) {\sum }_{l \neq d} {μ}_{ι l} {x}_{n l}^{t} {x}_{n d}^{t} \} - {\sum }_{s \neq t} {[ {C}_{d}^{- 1} ]}_{t s} {μ}_{s d} ) , \\ {λ}_{t d} ← {[ {C}_{d}^{- 1} ]}_{t t} + 2 {\sum }_{n = 1}^{{N}_{t}} h ( {ζ}_{n}^{t} ) {( {x}_{n d}^{t} )}^{2} , \\ {( {ζ}_{n}^{t} )}^{2} ← {x}_{n}^{t T} ( {Λ}_{t}^{- 1} + {μ}_{t} {μ}_{t}^{T} ) {x}_{n}^{t} ,\end{matrix} \}$$

Where

$$h ( {ξ}_{n}^{t} ) \text{:} = \frac{1}{2 {ξ}_{n}^{t}} ( σ ( {ξ}_{n}^{t} ) - \frac{1}{2} ) . \\ {μ}_{t} \text{:} = ( {μ}_{t 1} , … , {μ}_{t D} ) , and {Λ}_{t} \text{:} = diag ( {λ}_{t 1} , … , {λ}_{t D} )$$

ξₙ^{t} represents an approximate parameter corresponding to each data, and

σ represents a sigmoid function.

The distribution q(wₜ) at the time t can be obtained by the maximization of an objective function shown in the following expression (24), the objective function being obtained by approximating a regularization term R(w) using Reparameterization Trick. The maximization is numerically executable using, for example, a quasi-Newton method.

$$\begin{matrix} [ Formula 24 ] & \\ ℒ ( {μ}_{t} , {σ}_{t} ) = \frac{1}{J} \frac{ρ}{M} {\sum }_{j = 1}^{J} {\sum }_{y ∈ \{ 0 , 1 \}} {\sum }_{m = 1}^{{M}_{t}} p ( y \vert {x}_{m}^{t} , {w}_{t}^{( j )} ) log p ( y \vert {x}_{m}^{t} , {w}_{t}^{( j )} ) - \frac{1}{2} {\sum }_{d = 1}^{D} ( {[ {C}_{d}^{- 1} ]}_{tt} ( - {μ}_{t d}^{2} + {σ}_{td}^{2} ) + 2 {\sum }_{s = {t}_{1}}^{{t}_{L + U}} {[ {C}_{d}^{- 1} ]}_{{st}^{μ} s d} {μ}_{td} ) + \frac{1}{2} {\sum }_{d = 1}^{D} ( 1 + log {σ}_{t d}^{2} ) & ( 24 )\end{matrix}$$

where

Wₜ^{(j)}:=μₜ+σₜ⊙ϵₜ^{(j)},ϵₜ^{(j)}˜ [symbol] (0.I),

J represents the number of sample times.

Further, the dynamics parameter θ is updated using the quasi-Newton method. In the quasi-Newton method, a term related to θ of a lower limit L and a differential related to θ shown in the following expression (25) are used.

$$[ Formula 25 ] \\ ( 25 ) \\ \begin{matrix}L ( q ; θ , ξ ) = - \frac{1}{2} {\sum }_{d = 1}^{D} [ {μ}_{{.}_{d}}^{T} {C}_{d}^{- 1} {μ}_{{.}_{d}} + Tr ( {C}_{d}^{- 1} {Λ}_{d}^{- 1} ) + log ( det ( {C}_{d} ) ) ] + const \\ \frac{\partial L ( q ; θ , ξ )}{\partial {θ}_{d}} = \frac{1}{2} {μ}_{{.}_{d}}^{T} {C}_{d}^{- 1} {μ}_{{.}_{d}} + \frac{1}{2} Tr ( {C}_{d}^{- 1} \frac{\partial {C}_{d}}{\partial {θ}_{d}} ( {C}_{d}^{- 1} {Λ}_{d}^{- 1} - I ) )\end{matrix} \} \\$$

where

μ_{·d}=(μₜ_{₁}_{d}, . . . ,μₜ_{_{T}}_{d}), Λ_{d}:=diag(λₜ_{₁}_{d}, . . . ,λₜ_{_{T}}_{d})

I represents a unit matrix.

The learning section 13 can estimate a desired parameter by alternately repeatedly performing the update of q(W) and the update of θ until a prescribed convergence condition is satisfied using the above update expression. The prescribed convergence condition represents, for example, a state in which the number of update times set in advance is exceeded, a state in which a change amount of a parameter becomes a certain value or less, or the like.

The classifier creation section 14 functions as a prediction section that predicts the classification criterion of a classifier at an arbitrary time point including a future time point and the reliability of the classification criterion. Specifically, the classifier creation section 14 derives the prediction of the classification criterion of a classifier at future time t, and certainty expressing the reliability of the predicted classification criterion using the classification criterion of the classifier and the time-series change of the classification criterion that have been learned by the learning section 13.

When logistic regression is applied as the model of the classifier and a Gaussian process is applied as a time-series model expressing the time-series change of the classification criterion of the classifier, a probability distribution at which the classifier W is obtained at time t, that is greater than t_{L+U} is expressed by the following expression (26). Note that q(w_{t*}) is only required to be applied when t* is less than or equal to t_{L+U}.

$$\begin{matrix}[ Formula 26 ] & \\ \begin{matrix}p ( {ω}_{{t}_{*}} ) = {\prod }_{d = 1}^{D} p ( {ω}_{{t}_{*} d} ) \\ p ( {ω}_{{t}_{*} d} ) = \int p ( {ω}_{{t}_{*} d} \vert {ω}_{. d} ) q ( {ω}_{. d} ) d {ω}_{. d} = 𝒩 ( {ω}_{{t}_{*} d} \vert {m}_{t * d} , {σ}_{t * d}^{2} ) \\ {m}_{t * d} = {k}_{d}^{T} {C}_{d}^{- 1} {μ}_{. d} \\ {σ}_{t * d}^{2} = {k}_{d} ( {t}_{*} , {t}_{*} ) + {η}_{d}^{2} + {k}_{d}^{T} ( {C}_{d}^{- 1} {Λ}_{d}^{- 1} - I ) {C}_{d}^{- 1} {k}_{d}\end{matrix} \} & ( 26 )\end{matrix}$$

where

k_{d}:=(k_{d}(t*,t₁), . . . ,k_{d}(t*,t_{T})).

m_{t*d} represents the parameter (d-component) of the classifier, and

the reciprocal of σ_{t*d}² represents the certainty of the parameter (d-component) of the classifier.

Thus, the classifier creation section 14 can obtain the classifier of a predicted classification criterion at arbitrary time together with the certainty of the prediction. The classifier creation section 14 stores the predicted classification of the classifier and the certainty in the classifier storage section 15.

The classifier storage section 15 is realized by a semiconductor memory element such as a RAM (Random Access Memory) and a flash memory or a storage device such a hard disk and an optical disk and stores the created classification criterion of a classifier at future time and the certainty. A storage form is not particularly limited, and a data base form such as MySQL and PostgreSQL, a table form, a text form, or the like is illustrated by example.

[Classification Unit]

The classification unit 20 has a data input section 21, a data conversion section 22, a classification section 23, and a classification result output section 24 and performs classification processing in which data is classified using a classifier that has been created by the creation unit 10 and a label is output as described above.

The data input section 21 is realized by an input device such as a keyboard and a mouse and inputs various instruction information to a control unit or receives data to be classified in response to an input operation by an operator. Here, the received data to be classified is assigned time information at a certain time point. The data input section 21 may be the same hardware as that of the learning data input section 11.

The control unit is realized by a CPU or the like that performs a processing program and has the data conversion section 22 and the classification section 23.

The data conversion section 22 converts data to be classified that has been received by the data input section 21 into a combination of collection time and a feature vector like the data conversion section 12 of the creation unit 10. Here, since the data to be classified is assigned time information at a certain time point, the collection time and the time information are the same.

The classification section 23 refers to the classifier storage section 15 and performs the classification processing of data using a classifier at the same time as the collection time of data to be classified and the certainty of the classifier. For example, when logistic regression is applied as the model of the classifier and a Gaussian process is applied as a time-series model expressing the time-series change of the classification criterion of the classifier as described above, the probability that the label y of the data x is 1 is obtained by the following expression (27). The classification section 23 sets the label as 1 when the obtained probability is a prescribed threshold or more and sets the label as 0 when the obtained probability is smaller than the threshold.

$$\begin{matrix} [ Formula 27 ] & \\ \begin{matrix}p ( {y}_{n}^{{t}_{*}} = 1 \vert {x}_{n}^{{t}_{*}} ) = σ ( τ ( {\tilde{σ}}^{2} ) \tilde{μ} ) , \\ \tilde{μ} = {m}_{{t}_{*}}^{T} {x}_{n}^{{t}_{*}} , {\tilde{σ}}^{2} = {x}_{n}^{{t}_{*}} {}^{T} {\sum }_{{t}_{*}} {x}_{n}^{{t}_{*}} , \\ τ ( z ) = {( 1 + π z / 8 )}^{- \frac{1}{2}} ,\end{matrix} \} \\ where {m}_{{t}_{*}} := ( {m}_{t * 1} , … , {m}_{t * D} ) , \\ {\sum }_{{t}_{*}} is a diagonal matrix \\ whose diagonal elements are ( {σ}_{t * 1}^{2} , … {σ}_{t * D}^{2} ) . & ( 27 )\end{matrix}$$

The classification result output section 24 is realized by a display device such as a liquid crystal display, a printing device such as a printer, an information communication device, or the like and outputs the result of classification processing to an operator. For example, the classification result output section 24 outputs a label with respect to input data or outputs data obtained by assigning a label to input data.

[Creation Processing]

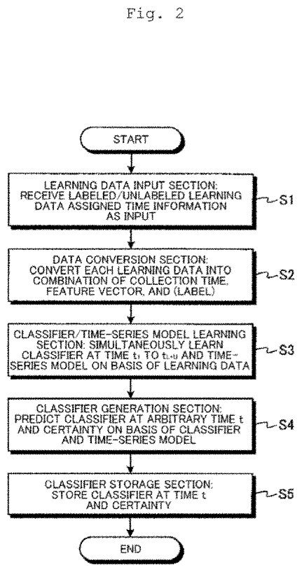

Next, the creation processing by the creation unit 10 of the creation device 1 will be described with reference to FIG. 2. FIG. 2 is a flowchart illustrating by example the creation processing procedure of the present embodiment. The flowchart of FIG. 2 starts at, for example, a timing at which an operation to instruct the start of the creation processing is input by a user.

First, the learning data input section 11 receives labeled learning data and unlabeled learning data that are assigned time information (step S1). Next, the data conversion section 12 converts the received labeled learning data into the data of a combination of collection time, a feature vector, and a numeric value label. Further, the data conversion section 12 converts the received unlabeled learning data into the data of a combination of collection time and a feature vector (step S2).

Then, the learning section 13 learns the classification criterion of a classifier until time t and a time-series model expressing the time-series change of the classifier (step S3). For example, a parameter wₜ of a logistic regression model and a parameter θ of a Gaussian process are simultaneously found.

Next, the classifier creation section 14 predicts the classification criterion of the classifier at arbitrary time t together with its certainty to create the classifier (step S4). For example, about a classifier to which a logistic regression model and a Gaussian process are applied, a parameter wₜ of the classifier at arbitrary time t and certainty are found.

Finally, the classifier creation section 14 stores the created classification criterion of the classifier and the certainty in the classifier storage section 15 (step S5).

[Classification Processing]

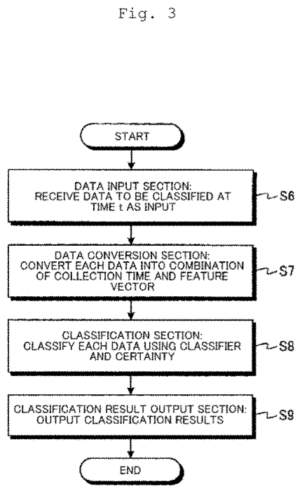

Next, the classification processing by the classification unit 20 of the creation device 1 will be described with reference to FIG. 3. The flowchart of FIG. 3 starts at, for example, a timing at which an operation to instruct the start of the classification processing is input by a user.

First, the data input section 21 receives data to be classified at time t (step S6), and the data conversion section 22 converts the received data into the data of a combination of collection time and a feature vector (step S7).

Next, the classification section 23 refers to the classifier storage section 15 and performs the classification processing of the data using the certainty with a classifier at the collection time of the received data (step S8). Then, the classification result output section 24 outputs a classification result, that is, the label of the classified data (step S9).

As described above, in the creation device 1 of the present embodiment, the learning section 13 learns the classification criterion of a classifier at each time point and the time-series change of the classification criterion using labeled learning data that was collected until a past prescribed time point and unlabeled learning data that was collected after the prescribed time point, and the classifier creation section 14 predicts the classification criterion of the classifier at an arbitrary time point including a future time point and the reliability of the classification criterion using the learned classification criterion and the time-series change.

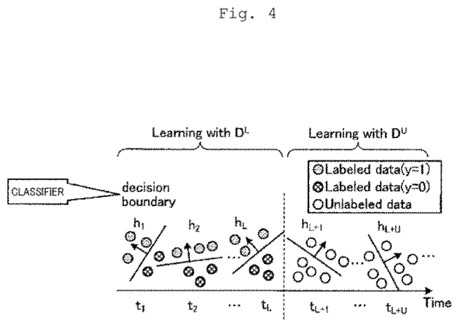

That is, as illustrated by example in FIG. 4, the learning section 13 learns the classification criterion of a classifier hₜ (h₁, h₂, . . . , h_{L}, h_{L+1}, . . . , h_{L+U}) at time t of t₁ to t_{L+U} and the time-series change of the classification criterion, that is, a time-series model expressing dynamics using input labeled learning data D^{L} at collection time t of t₁ to t_{L} and unlabeled learning data D^{U} at collection time t of t_{L+1} to t_{L+U} up to the present.

In the example shown in FIG. 4, a classification criterion and the time-series change of the classification criterion are learned using the labeled learning data of y=0 and the labeled learning data of y=1 that were collected at time t of t₁ to t_{L} and unlabeled learning data that was collected at time t of t₁ to t_{L+U}. Then, the classifier creation section 14 predicts a classification criterion hₜ at future arbitrary time t and the certainty of the predicted classification criterion h and creates the classifier hₜ at the arbitrary time t.

Thus, according to the creation processing of the creation unit 10 in the creation device 1 of the present embodiment, the time development of a classification criterion learned only from labeled learning data can be corrected using unlabeled learning data that was collected on and after the collection time point of the labeled learning data. Further, a future classification criterion is predicted together with certainty using labeled learning data and unlabeled learning data that is low in collection cost. Accordingly, the selective use of a classifier with consideration given to the certainty of a predicted classification criterion makes it possible to prevent a decrease in the classification accuracy of the classifier and perform classification with high accuracy. As described above, according to the creation processing of the creation device 1, a classifier maintaining its classification accuracy can be created using unlabeled learning data with consideration given to the time development of a classification criterion.

Further, particularly when the classification criterion of a classifier and the time-series change of the classification criterion are simultaneously learned, more secured learning can be performed compared with a case in which the classification criterion of the classifier and the time-series change of the classification criterion are separately learned even in, for example, a case in which the number of labeled learning data is small.

Note that the creation processing of the present invention is not limited to a classification problem in which a label is composed of discrete values but may include a regression problem in which a label is composed of actual values. Thus, the future classification criteria of various classifiers can be predicted.

Further, the past collection time of labeled learning data and unlabeled learning data may not be continuous at a constant discrete time interval. For example, when a Gaussian process is applied as a time-series model expressing the time-series change of the classification criterion of a classifier as in the above embodiment, the classifier can be created even if a discrete time interval is nonuniform.

### Second Embodiment

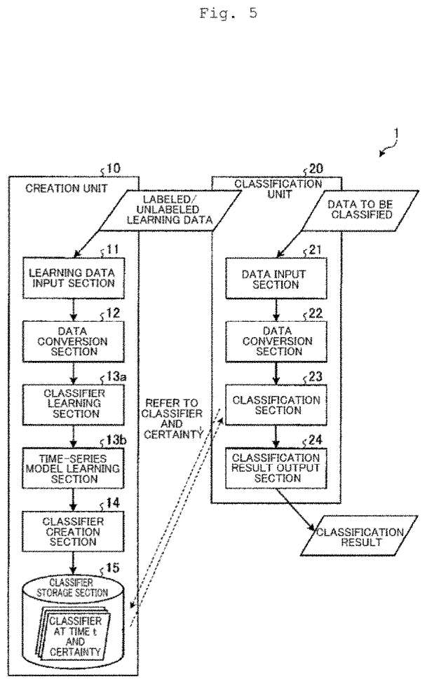

The learning section 13 of the above first embodiment may be separated into a classifier learning section 13a and a time-series model learning section 13b. FIG. 5 is a diagram illustrating by example the schematic configuration of a creation device 1 of a second embodiment. The present embodiment is different only in that the processing by the learning section 13 of the first embodiment is shared by the classifier learning section 13a and the time-series model learning section 13b. In the present embodiment, the learning of a time-series change by the time-series model learning section 13b is performed after the learning of a classification criterion by the classifier learning section 13a. The other points are the same as those of the first embodiment and thus their descriptions will be omitted.

Note that in the present embodiment, logistic regression is applied as the model of a classifier and a Gaussian process is applied as a time-series model expressing the time-series change of the classification criterion of the classifier like the above first embodiment. Note that the time-series model is not limited to the Gaussian process but may include a model such as a VAR model.

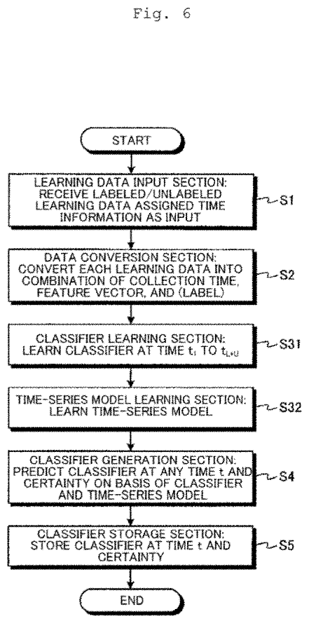

FIG. 6 is a flowchart illustrating by example the creation processing procedure of the present embodiment. Only the processing of step S31 and the processing of step S32 are different from those of the above first embodiment.

In the processing of step S31, the classifier learning section 13a learns the classification criterion of a classifier at arbitrary time t using labeled learning data at collection time t of t₁ to t_{L} and unlabeled learning data at collection time t of t_{L+1} to t_{L+U}. For example, a parameter wₜ at time t of a logistic regression model is found.

In the processing of step S32, the time-series model learning section 13b learns a time-series model expressing the time-series change of the classification criterion using the classification criterion of the classifier until the time t that has been obtained by the classifier learning section 13a. For example, a parameter θ of a Gaussian process is found.

As described above, the classification criterion of a classifier and the time-series change of the classification criterion are separately learned in the creation device 1 of the present embodiment. Thus, even, for example, when the numbers of labeled learning data and unlabeled learning data are great, it is possible to lighten processing loads on respective function sections and perform processing in a short period of time compared with a case in which the classification criterion of a classifier and the time-series change of the classification criterion are simultaneously learned.

[Program]

A program in which the processing performed by the creation device 1 according to the above embodiment is described in language executable by a computer can be generated. As an embodiment, the creation device 1 can be mounted when a creation program for performing the above creation processing is installed in a desired computer as package software or online software. For example, an information processing device can function as the creation device 1 by performing the above creation program. Here, the information processing device includes a desktop or notebook personal computer. Besides, the information processing device includes a mobile body communication terminal such as a mobile phone and a PHS (Personal Handyphone System) and a slate terminal such as a PDA (Personal Digital Assistants), or the like. Further, assuming that a terminal device used by a user is a client, the creation device 1 can be mounted in the client as a server device that provides a service related to the above creation processing. For example, the creation device 1 is mounted as a server device that receives labeled learning data as input and provides a creation processing service to output a classifier. In this case, the creation device 1 may be mounted as a web server, or may be mounted as a cloud that provides a service related to the above creation processing by outsourcing. Hereinafter, an example of a computer that performs a creation program to realize the same function as that of the creation device 1 will be described.

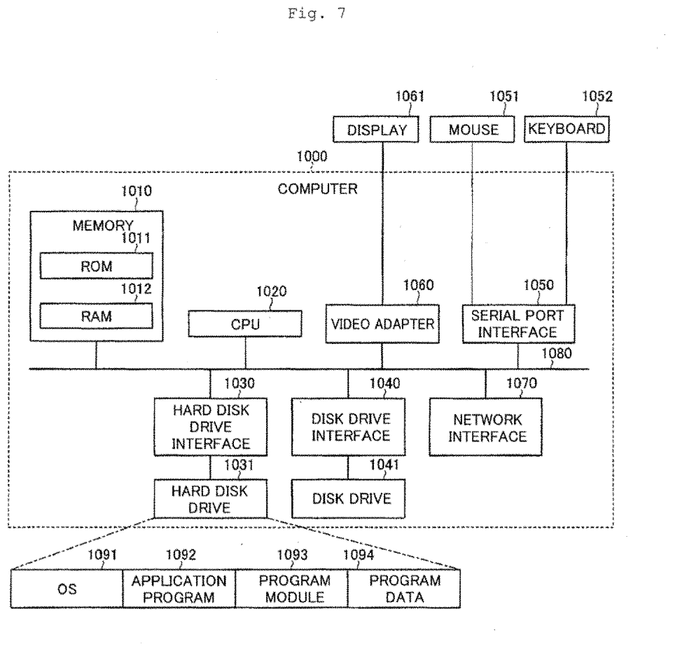

FIG. 7 is a diagram showing an example of a computer 1000 that performs a creation program. The computer 1000 has, for example, a memory 1010, a CPU 1020, a hard disk drive interface 1030, a disk drive interface 1040, a serial port interface 1050, a video adapter 1060, and a network interface 1070. These respective units are connected to each other via a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to the hard disk drive 1031. The disk drive interface 1040 is connected to a disk drive 1041. For example, a detachable storage medium such as a magnetic disk and an optical disk is inserted into the disk drive 1041. For example, a mouse 1051 and a keyboard 1052 are connected to the serial port interface 1050. For example, a display 1061 is connected to the video adapter 1060.

Here, the hard disk drive 1031 stores, for example, an OS 1091, an application program 1092, a program module 1093, and program data 1094. The respective information described in the above embodiment is stored in, for example, the hard disk drive 1031 or the memory 1010.

Further, the creation program is stored in the hard disk drive 1031 as, for example, the program module 1093 in which an instruction performed by the computer 1000 is described. Specifically, the program module 1093 in which the respective processing performed by the creation device 1 described in the above embodiment is stored in the hard disk drive 1031.

Further, data used for information processing based on the creation program is stored in, for example, the hard disk drive 1031 as the program data 1094. Then, the CPU 1020 reads the program module 1093 or the program data 1094 stored in the hard disk drive 1031 into the RAM 1012 where necessary to perform the respective procedures describe above.

Note that the program module 1093 or the program data 1094 according to the creation program may be stored in, for example, a detachable recording medium rather than being stored in the hard disk drive 1031 and read by the CPU 1020 via the disk drive 1041 or the like. Alternatively, the program module 1093 or the program data 1094 according to the creation program may be stored in other computers via a network such as a LAN (Local Area Network) and a WAN (Wide Area Network) and read by the CPU 1020 via the network interface 1070.

The embodiment to which the present invention made by the present inventor is applied is described above. However, the present invention is not limited to the descriptions and the drawings constituting a part of the disclosure of the present invention according to the present embodiment. That is, other embodiments, examples, operation technologies, or the like made by persons skilled in the art or the like on the basis of the present embodiment are all included in the scope of the present invention.

### REFERENCE SIGNS LIST

1 Creation device
10 Creation unit
11 Learning data input section
12 Data conversion section
13 Learning section
13a Classifier learning section
13b Time-series model learning section
14 Classifier creation section
15 Classifier storage section
20 Classification unit
21 Data input section
22 Data conversion section
23 Classification section
24 Classification result output section

1. A creation device for creating a classifier that outputs a label expressing an attribute of input data, the creating device comprising:
a classifier learning section that learns a classification criterion of the classifier at each time point using labeled data collected until a past prescribed time point and unlabeled data collected on and after the prescribed time point as learning data;
a time-series change learning section that learns a time-series change of the classification criterion; and
a prediction section that predicts a classification criterion of the classifier at an arbitrary time point including a future time point and reliability of the classification criterion using the learned classification criterion and the time-series change.

2. The creation device according to claim 1, wherein the data is data in which a discrete time interval is nonuniform.

3. The creation device according to claim 1, wherein the time-series change learning section learns the time-series change in parallel with the learning of the classification criterion by the classifier learning section.

4. The creation device according to claim 1, wherein the time-series change learning section learns the time-series change after the learning of the classification criterion by the classifier learning section.

5. A creation method performed by a creation device for creating a classifier that outputs a label expressing an attribute of input data, the creating method comprising:
a classifier learning step of learning a classification criterion of the classifier at each time point using labeled data collected until a past prescribed time point and unlabeled data collected on and after the prescribed time point as learning data;
a time-series change learning step of learning a time-series change of the classification criterion; and
a prediction step of predicting a classification criterion of the classifier at an arbitrary time point including a future time point and reliability of the classification criterion using the learned classification criterion and the time-series change.

6. A non-transitory computer readable medium storing a creation program which causes a computer to perform:
a classifier learning step of learning a classification criterion of a classifier at each time point using labeled data collected until a past prescribed time point and unlabeled data collected on and after the prescribed time point as learning data;
a time-series change learning step of learning a time-series change of the classification criterion; and
a prediction step of predicting a classification criterion of the classifier at an arbitrary time point including a future time point and reliability of the classification criterion using the learned classification criterion and the time-series change.
